(19) United States
(12) Patent Application Publication
(10) Pub. No.: US 2019/0069514 A1
(43) Pub. Date: Mar. 7, 2019

(54) Equine Rocker Shoe

(71) Applicant: Monty L. Ruetenik, Clear Lake Shores, TX (US)

(72) Inventor: Monty L. Ruetenik, Clear Lake Shores, TX (US)

(21) Appl. No.: 15/697,362

(22) Filed: Sep. 6, 2017

(51) Int. Cl. A01K 13/00

(52) U.S. Cl. CPC A01K 13/007; A01L 7/02

(57) ABSTRACT

An equine accomodative hoof support (rocker shoe) system consisting of a tapered base that allows, in some embodiments, the equine hoof to roll forward or to the side, without unnecessary bending, thus allowing it to find a comfortable natural position to relieve stress on a sore, injured, or diseased hoof. The ability of the base to rock allows the equine to adjust its stance to find the most comfortable position, not unlike standing in a bed of sand. The system can replace expensive hoof treatment by a farrier and can easily be utilized directly by an equine practitioner or equine owner. The system provides an efficient, user friendly self-adjusting approach to sole supportive realignment of the P3 (third phalanx) as the hoof grows out.

### BACKGROUND

### Field of the Invention

This invention relates to an equine accommodative orthotic hoof support system that has a tapered bottom to facilitate breakover when walking and which includes, optionally, a series of shock absorbing orthotic pads of varying thickness to allow customization.

### Background

It has been reported that the estimated economic loss due to lameness in horses is between $678 million and $1 billion annually (USDA-APHIS, 2001). Although there are many reasons, sole bruising and disease such as laminitis are a common cause of lameness in horses. As explained in the website www.therapeutichorseshoeing.com, “Laminitis or ‘founder’ is an equine hoof disease where the coffin bone (third phalanx, P3) begins to lose its attachment to the inner hoof wall and begins to rotate toward the front of the hoof or sink within the hoof capsule. Laminitis is generally thought to result from an imbalance in the horse's internal system. For example, an injury or upset to some part of the body is combated by the circulatory system as blood rushes to the injured area. The momentary reduction in blood flow deprives the capillaries which feed the lamina. The lamina is the ‘Velcro’ that attaches the bone to the hoof wall. In the brief time the lamina lacks sufficient blood flow, the capillaries begin to die and the ‘Velcro’ attachment is weakened. The deep flexor tendon is attached to the bottom (palmar surface) of the coffin bone. This tendon is an extension of a muscle which reacts to the pain of the tearing lamina. As the muscle contracts, the tendon is in tension and pulls on the coffin bone. Once this pain cycle is established, it must be broken before healing can begin.”

While lameness, especially that caused by laminitis is difficult to cure, it is possible to relieve some of the pressure and pain through proper trimming, or by using shoes or boots that allow the horse to find a comfortable position and relieves unnecessary pressure on a lame hoof. Such relief is often essential to an eventual cure.

One commercial shoe that has found acceptance is sometimes referred to as a “banana” or “rocker” shoe or clog. This shoe is shaped to allow breakover adjustment by a “rocker” action of the sole of the hoof so that the horse can more easily find a comfortable position—by adjusting the palmar/planar angle to take pressure and stress off affected areas of the hoof. The “Clog,” developed by Dr. Micheal L. Steward, DVM of Oklahoma, utilizes the “self-adjusting” concept in a wooden shoe that is screwed and/or glued directly to the hoof. Adaptations of the Stewart Clog have been made of other materials as well. These shoes, while somewhat effective, are attached directly to the hoof and are not, therefore, easily changed without damage to the hoof. The present invention is an equine shoe system that overcomes the deficiencies of other shoes or boots.

### BRIEF SUMMARY OF THE INVENTION

This invention is an equine accomodative hoof support system consisting of a tapered base that allows, in some embodiments, the equine hoof to roll forward or to the side, without unnecessary bending, thus allowing it to find a comfortable natural position to relieve stress on a sore, injured, or diseased hoof. The ability of the base to rock allows the equine to adjust its stance to find the most comfortable position, not unlike standing in a bed of sand. This ability to find a naturally comfortable standing position is especially important for equine with lameness such as laminitis.

One benefit of the present invention is that it can replace expensive hoof treatment by a farrier and can easily be utilized directly by an equine practitioner or equine owner. The hoof support system of this invention provides an efficient, user friendly self-adjusting approach to sole supportive realignment of the P3 (third phalanx) as the hoof grows out. Another advantage of the sloped base of the shoe is that it greatly reduces the surface area in contact with the ground or other surface onto which the equine stands.

### DESCRIPTION OF THE DRAWINGS

A more complete understanding of the method and apparatus of the present invention may be had by reference to the following detailed description when taken in conjunction with the accompanying drawings, wherein:

FIG. 1 is bottom elevation view of an embodiment of the rocker shoe system of invention.

FIG. 2 is top elevation view of an embodiment of the rocker shoe system of the invention.

FIG. 3 is rear elevation view of an embodiment of the rocker shoe system of invention.

FIG. 4 is front elevation view of an embodiment of the rocker shoe system of the invention.

FIG. 5 is side elevation view of an embodiment of the rocker shoe system of invention.

FIG. 6 is a perspective view of an embodiment of the rocker shoe system of the invention as viewed from the bottom.

FIG. 7 is perspective view of an orthotic pad of an embodiment of the rocker shoe system of the invention.

FIG. 8A is a perspective view showing the way in which an orthotic pad is placed into the rocker shoe system of an embodiment of the invention.

FIG. 8B is a perspective view of an assembly of a pad, base, and shoe rim of an embodiment of the rocker shoe system of the invention.

FIG. 8C another perspective view of an assembly of a pad, base, and shoe rim of an embodiment of the rocker shoe system of the invention

FIG. 9A is side elevation view of an embodiment of the rocker shoe system of invention showing a tapered base.

FIG. 9B is a perspective view of an assembly of a pad and shoe of an embodiment of the rocker shoe system of the invention showing a tapered base.

FIG. 10 is a perspective view of an assembly of a pad, base, and shoe rim of an embodiment of the rocker shoe system of the invention showing a detachable shoe rim.

All figures are drawn for ease of explanation of the basic teachings of the present invention only; the extensions of the figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION

In the following detailed description, reference is made to the accompanying drawings that form a part hereof, and in which is shown by way of illustration specific implementations (embodiments) which may be practiced. These implementations are described in sufficient detail to enable those skilled in the art to practice the implementations, and it is to be understood that other implementations may be utilized. Further, logical, mechanical, and other changes may be made without departing from the scope of the implementations. The following detailed description is, therefore, not to be taken in a limiting sense.

In broad aspect, the present invention is an equine accomodative hoof support or rocker shoe system that has a tapered base of flexible polymer and a harder shoe rim disposed on the topside of the base. The shoe rim forms a complete enclosed receptacle that acts to constrain the lateral expansion of an elastomer gel orthotic pad that may be placed in the space inside the open section of the shoe rim enclosure. The system also, optionally, includes a shock-absorbing elastomer pad removably disposed in the space inside the shoe rim and on the top surface of the base. The base may be patterned. The base, in some embodiments, has a critical range of hardness that allows it to remain sufficiently flexible to be able to push the top surface of the base upward when pressure of an equine body weight is placed on it, as further explained below. Accommodative orthotic systems are used to distribute the body weight away from a painful area and/or provide needed support to decrease pain.

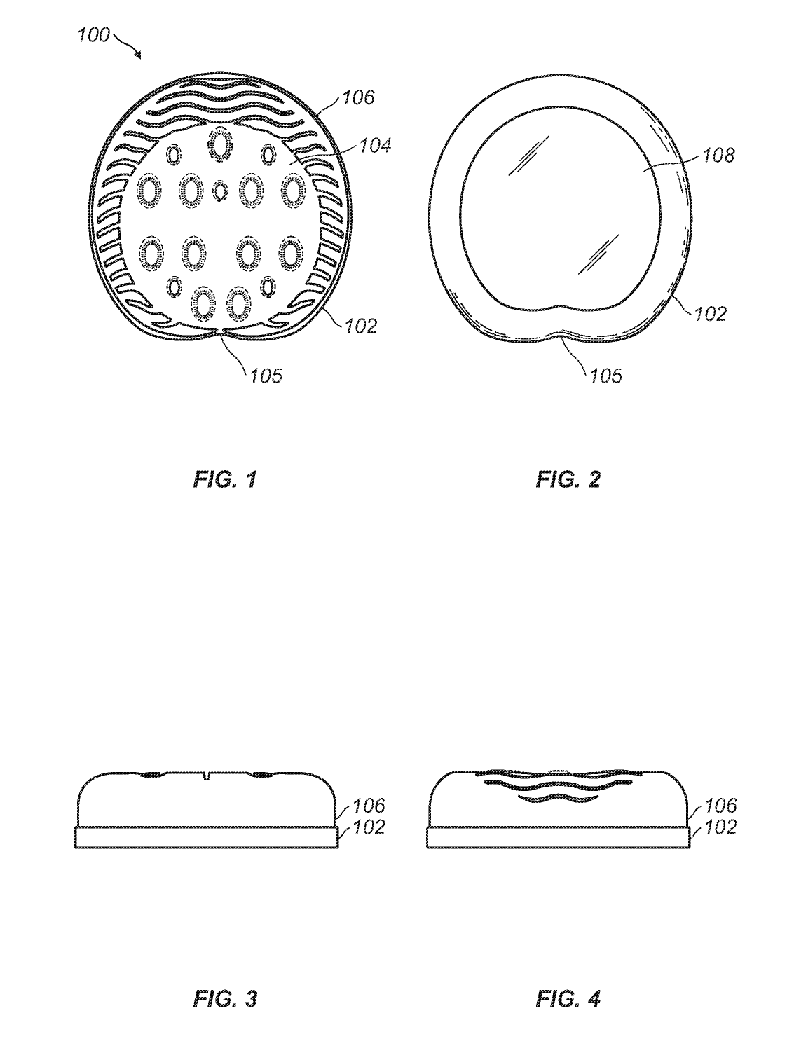

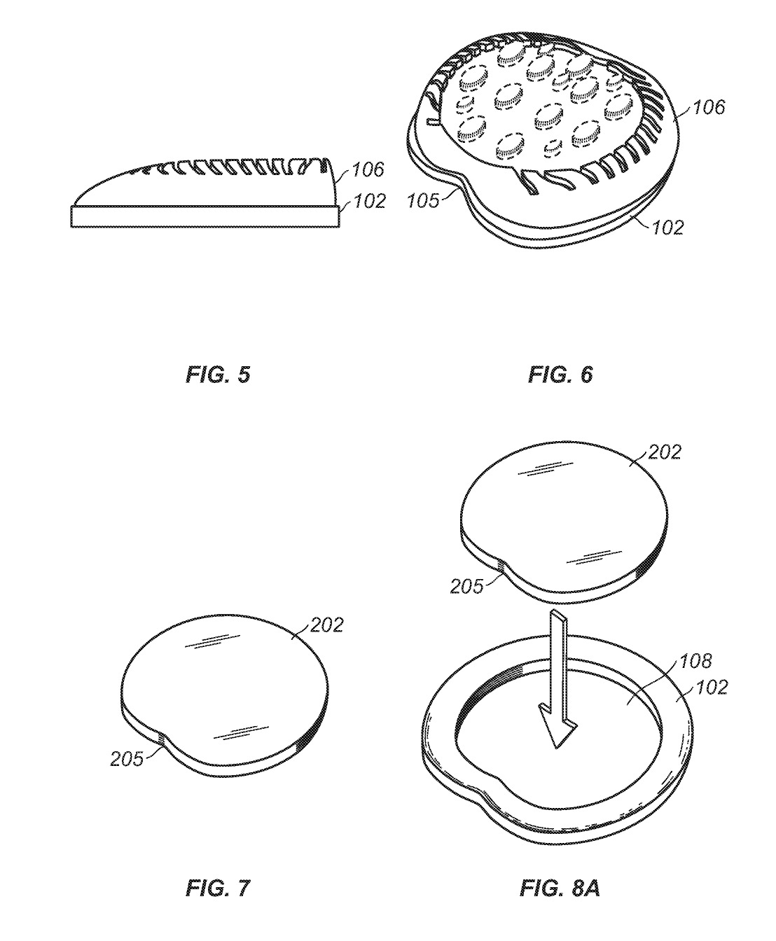

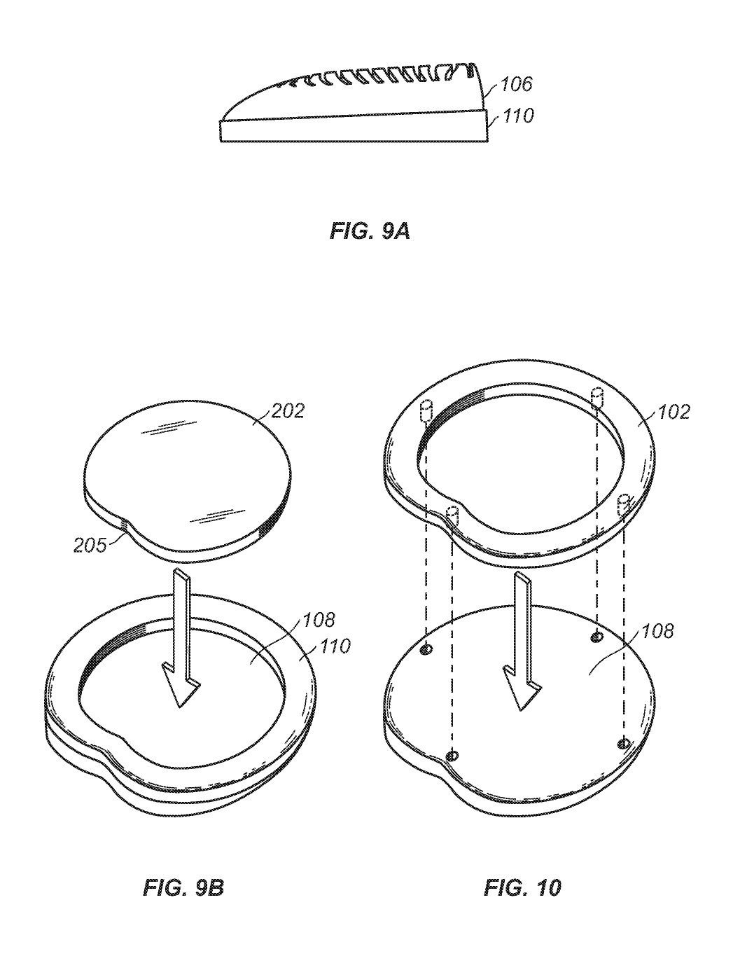

Referring to the figures that are exemplary of embodiments of the invention, FIG. 1 is a bottom view of the shoe system. The system consists of a base 106 and shoe rim 102. Lead line 105 (and 205 in FIG. 9B) points to a wide V-shape end of the shoe rim. This shape, better shown in FIG. 6, helps to orient and position an orthotic pad that is placed in the recess made by the shoe rim. This or other irregular shape that prevents rotation of a shock-absorbing elastomer pad that may be placed therein is preferred. The drawings show a patterned bottom side (104) of the base 106. The base may be patterned (104) in any manner or not at all. The patterning (104) helps the shoe grip the ground and prevent slipping, but it is not essential. The patterning as shown is also useful in facilitating the necessary flexing of the base as explained below. FIG. 2 is a top view showing a plan view of the shoe rim structure 102. In a prototype, this structure is ⅜-inches thick (distance that it projects upward from the surface of the topside of the base). This shoe rim structure is slightly wider than the bottom side of the base as can be seen more clearly in FIG. 6). This forms a slight ridge to facilitate better attachment to an equine hoof (as by nailing or taping with suitable taping material customarily used in equine leg casting). FIG. 3 is a rear view, FIG. 4 a front view (front and rear determined by the way the shoe system fits on an equine). FIG. 5 is a side view showing the sloped shape of the system base. This sloped base is important as is detailed below. FIG. 6 is a perspective view of the rocker shoe system.

An important feature of the shoe system of this invention is the ability of the rocker base (106 in the Figures) to flex when pressure is applied (as when attached to an equine and the equine is standing on the shoe). When pressure is applied to the base the inside surface 108 of the base is pushed upward. This causes a pad in the recess to be pushed upward and fill the space in the underside of the hoof to provide support. When the equine lifts its hoof, pressure is released and the pad returns to the original position without pressure on the hoof bottom. This relief from constant pad pressure on the underside of the hoof distinguishes this system from other similar shoeing means. For example, farriers sometimes fill the underside off the hoof cavity with a filler. This keeps constant pressure on the hoof underside and can be the cause of irritation, soreness, and infections. Other solid-surface shoes with or without pads similarly apply constant pressure to the hoof underside. The flexible shoe base of the present system is thus very different. The flexibility (evidenced by Shore A hardness of the base composition) as well as the shape of the base is critical. The base must be of a polymer having a Shore A hardness of from about 50-80 and preferably 60 to 70. The harder shoe rim (102 in the Figures) is harder, having a critical hardness of about 75-95 Shore A, or 75 Shore A to 65 Shore D, with a hardness of Shore A of about 90 to 95 being preferred. It is also preferred that the shoe be made of a polymer that has a composition structure that is like that of a natural hoof. A two-component, low-viscosity, rapid-setting urethane compound polymer with high strength and durometer is very suitable. It is easily nailed, holds the nails tightly, and otherwise simulates the characteristics of a natural hoof composition. It is important that the shoe structure form a complete surround to constrain the orthotic pad from lateral expansion. As explained above, by constraining lateral expansion, the elastomeric orthotic pad will be forced upward (into the underside of the hoof when pressure is applied on the shoe base) and cause it to conform to the shape of the hoof's underside cavity. This is an important aspect to the function of an embodiment of the shoe system of this invention.

In the above described embodiments, the shoe rim, 102, will be relatively hard as detailed above but in other embodiments the rim may be relatively soft (Shore A of about 50-80 and preferably 60 to 70) and the orthotic relatively hard (Shore A of about 60 to 90). This configuration will provide relief to the hoof wall (relieve the wall from undue pressure, which is important in relief for laminitic equine) and provide more support on the underside of the hoof. The orthotic pad may also have a frog support (as illustrated) for similar orthotic pad disclosed in U.S. Pat. No. 8,220,231, issued Jul. 17, 2012, U.S. D709,656 issued Jul. 2, 2014, and U.S. application Ser. No. 29/581,806 filed June 2008 581,806. The disclosures of these patents and application are incorporated herein by reference.

The shoe system can be attached to an equine hoof by conventional nailing, screwing, or gluing. Suitable techniques for such attachment are well known in the art. Suitable glues are readily available and include both acrylic-based glues and urethane-based glues. Both are two-part glues in which curing is achieved through a chemical reaction between the two parts. Equilox™ and Equibond™ are examples of suitable commercial shoe glues. The shoe system may also be attached to an equine hoof through the wrapping of casting material or by duct taping it to the cast. Attachment by wrapping will be very convenient for many users as the shoes usually need to be changed and the hoof worked on about every 3 to 6 weeks as the hoof grows. A new casting tape, Braeon™, that hardens into a very strong and durable material upon heating, may be very useful in attaching the shoes. Braeön™ is a high strength, lightweight plastic ribbon that molecularly fuses to itself in a matter of seconds. Users only need to simply heat, press, and repeat to form the plastic into any desired shape. Once cooled, the self-bonding plastic hardens, creating a bond as strong as steel. It is available through the company, see http://braeon.com/about-braeon.

One farrier attaches a prototype of the rocker shoe to horse's hooves with screws in the front of the hoof to stabilize the hoof temporarily and then wraps the hoof and sides of the shoe with traditional casting tape. The shoe shape is an advantage as well as the ease with which it may be shaped and custom-fitted to an individual hoof by a common farriers' rasp—no special tools needed. Attaching with casting tape minimizes damage to the hoof (as could result from nailing the shoe to the hoof) and provides an attachment that can be easily replaced (generally shoes need to be replaced or reset about every 3-6 weeks because of hoof growth).

The shoe base, 106, and shoe rim, 102, may suitable be made of molded elastomeric polymer. Molded polyurethane is very suitable and convenient to work with. Shore A of about 90 is especially suitable. Polyurethanes are easily moldable in open molds or by injection molding. Other polymer materials with similar characteristics as polyurethane, such as polyvinyl chlorides, styrene butadiene styrene polymer, epoxies, and the like, are also usable. It is also suitable to incorporate filaments or fibers (such as Dyeema or Teflon™ fiber) or Teflon™ powder, to strengthen and improve abrasion resistance of the base. Choice of these materials will be well within the ability of those skilled in the polymer art to select.

As shown in the Figures (FIG. 5), the base is sloped towards the front. The front will be tapered but the rear will be essentially flat (but rounded at the end) from the center of the structure rearward. This rocker configuration provides the equine a more stable footing in a preferred neutral resting position. The neutral resting position in the rear section of the device enables the horse to have a stable place to rest, yet if there is movement fore and rear the hoof or laterally, the rocker rolls to lessen torque on the tendons, ligaments, and especially on the compromised lamina.

Alternatively, the base can be tapered (sloped) toward the front of the hoof and tapered towards the rear and/or from side-to-side. While not shown in the Figures, the shoe system base, can slope from the centerline-side to side-side—to allow the hoof to rotate or tilt from side-to-side as well as forward. Tapering to the side can also be beneficial in relieving pressure when the hoof is turning since during turning there is generally the most pressure upon and therefore the most damage to the coffin bone and lamina. This allows maximum flexibility of movement and enables the horse to find the optimum position of comfort; however, it is the least stable of the configurations. This sole shape is useful to enhance self-stretching of ligaments as when preparing for exercise, much like a person stretching their Achilles tendons by leaning on a wall before a run.

Both taper configurations are useful in appropriate situations, and both are within the scope of this invention. Several possible rocker shapes are described in co-pending U.S. published applications. 2011/0067366, Mar. 24, 2011 (Ser. No. 12/882,352), and U.S. D728,867 issued May 5, 2015, the disclosure of which are incorporated herein by reference for all purposes.

Another advantage of the sloped base of the shoe is that it greatly reduces the surface area in contact with the ground or other surface onto which the equine stands. For example, a typical hoof bottom would be about 8 inches×8 inches or 64 square inches. A suitable shoe sole should be about 4 inches×5 inches or 20 square inches, which is only about 30% of the surface of the hoof bottom. Smaller shoe bases would reduce the ground contact even further.

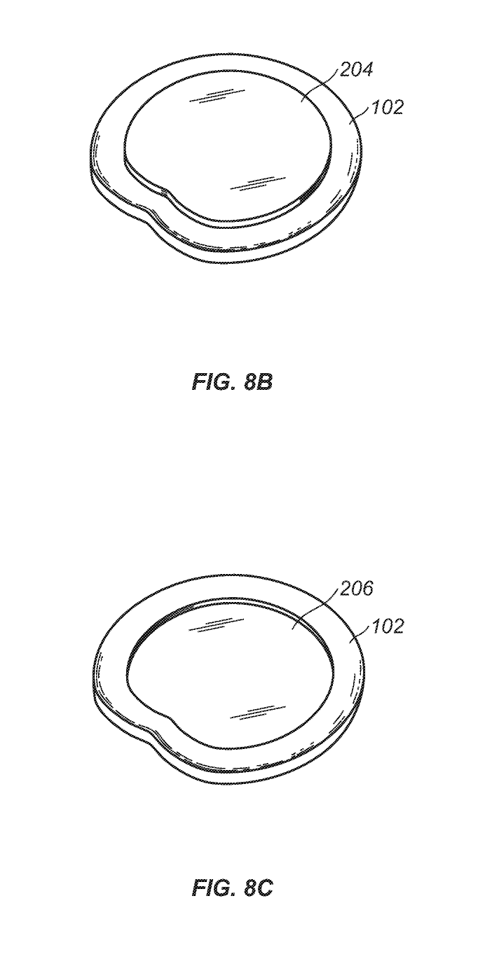

An orthotic pad, 202, 204 and 206, is illustrated in FIGS. 7, 8A, 8B, and 8C. The pads are shock-absorbing elastomer of Shore A hardness of about 15-30. Polyurethanes gels are preferred. The composition and manufacture of such pads (but slightly different shape) are detailed in U.S. Pat. No. 7,445,051, issued Nov. 4, 2008, the disclosure of which is incorporated herein by reference. Also detailed in the U.S. Pat. No. 7,445,051 is dual-density orthotic pads, that are suitable for use in the system of this application. The pad may be the width (top to bottom measurement) of the shoe rim so that the top of the pad is flush with the top of the shoe rim and may be of greater width (FIG. 8B or lesser width (FIG. 8C). As discussed above, the wide V-shape (105) in the rear of shoe rim helps to orient the pad and hold it in place (keeps it from rotating when in use). Orientation is especially important with dual-density pads. Other rim shapes that aid in orientation are also suitable. The different pad thicknesses allow the user to customize the system for the desired effect. The idea is that the user could simply decide to use the less thick pad if he/she determines constant pressure on the hoof wall is best, or perhaps a pad of equal thickness would be chosen if constant pressure on the sole is desired. If more pressure is what is needed on the hoof underside, a thicker pad would be chosen. The pad of the system is easily tailored without the need to buy an entirely new shoe system for each use. Thus, the use of thicker pads could easily and simply accommodate a horse who, for example, has been fitted with original metal shoes. This adaptability makes the system of this invention simple, user friendly and cost-effective as it allows the user (or equine practitioner) to avoid the need for an expensive podiatrist to do changes or adaptations as the hoof pathology changes and the treatment protocols require. In many current clog systems, the farrier podiatrist will attach an aggressive shoeing package and with many changes resulting in inefficient and costly rescheduling the farrier/podiatrist. The present system allows the user to make the necessity changes by simple choice of pads and shoe rims that can be removably attached to the hoof. The ability to use the system with equine wearing metal shoes is also a significant advantage. Most all other clogs require the use of shoe pullers to be used to get the metal shoe off before any big mechanical advantage can be applied. This can be very problematic to an already compromised hoof capsule and weakened lamina. So, in an emergency (acute) situation an owner or ambulatory veterinarian could very easily tape the present system on over the metal shod hoofs. The same procedure can be used for the horse that has a soft tissue injury (ligaments and tendon) and by simply taping this mechanics on the hoof eliminate/minimize more damage to those compromised soft tissues.

In other embodiments, the shoe rim (110) may be tapered as shown in FIGS. 9A and 9B. The tapered shoe rim adds additional slope to facilitate better breakover when such is needed.

FIG. 10 is a perspective view of an assembly of a pad, base, and shoe rim of an embodiment of the rocker shoe system of the invention showing a detachable shoe rim. A detachable shoe rim can add a useful option for the user. Removable rims can be of a variety of hardness, taper or straight or other configurations. This allow customization for the user without the necessity of purchasing the entire system of base and rim. As shown there are dowels in the underside of the rim that fit into matching holes in the base. Other means of aligning the rim and base are within the ability of those skilled in the art. Once aligned, the rim and base may be secured together by friction fit of the dowels and holes (or other orienting means) or by suitable adhesive means.

In the foregoing specification, the invention has been described with reference to specific embodiments thereof. It will, however, be evident that various modifications and changes can be made thereto without departing from the broader spirit and scope of the invention as set forth in the appended claims. The specifications and drawings are, accordingly, to be regarded in an illustrative rather than a restrictive sense. Therefore, the scope of the invention should be limited only by the appended claims.

1. An equine rocker shoe system comprising:
a tapered flexible base structure, having a top side and underside, made of an elastomer polymer, having a critical Shore A hardness in the range of about 50-80,
a harder shoe rim structure disposed on the top side of the base having an open center section defining a receptacle area to receive a shock-absorbing elastomer pad—the rim structure having a critical harness of about Shore A 90 to Shore D 65.

2. The equine rocker shoe system of claim 1 also comprising a shock-absorbing elastomer pad sized to fit into the receptacle area formed by the shoe rim structure.

3. The equine rocker shoe system of claim 1 wherein the shoe rim structure has a front and back and is tapered front to back.

4. The equine rocker shoe system of claim 1 shoe rim structure is detachable from the base.

5. The equine rocker shoe system of claim 2 wherein the shock-absorbing elastomer pad is made of a polyurethane elastomer gel, having a critical Shore A hardness of about 15-30.

6. The equine rocker shoe system of claim 2 wherein the shock absorbing elastomer pad has a critical hardness of about 15-30 Shore A and is comprised of a front section of one hardness, and a rear section of a different hardness.

7. The equine rocker shoe system of claim 1 wherein the underside of the base structure is patterned.

8. The equine rocker shoe system of claim 1 wherein the base has a front, rear, and centerline and is tapered toward the front from about the centerline as measured from front to rear and has a rounded rear edge.

9. The equine rocker shoe system of claim 1 wherein the shoe rim structure is of lower hardness than the base.

10. The equine rocker shoe system of claim 1 rim structure is shaped to form an irregular shape to prevent rotation of a shock-absorbing elastomer pad that may be placed therein.

11. A method of providing accommodative hoof support for an equine comprising:
a) examining an equine hoof to determine what support is needed;
b) selecting an equine rocker shoe system suitable to provide the needed support; and
c) attaching the equine rocker shoe system to the underside of the equine hoof; wherein the equine rocker shoe system comprises:
a tapered flexible base structure, having a top side and underside, made of an elastomer polymer, having a critical Shore A hardness in the range of about 50-80,
a harder shoe rim structure disposed on the top side of the base having an open center section defining a receptacle area to receive a shock-absorbing elastomer pad—the rim structure having a critical harness of about Shore A 90 to Shore D 65.

12. The method of claim 11 wherein the equine rocker shoe system is attached to the equine hoof by nailing, adhesive of wrapping with casting tape.

13. The equine rocker shoe system of claim 11 also comprising a shock-absorbing elastomer pad sized to fit into the receptacle area formed by the shoe rim structure.

14. The equine rocker shoe system of claim 11 wherein the shoe rim structure has a front and back and is tapered front to back.

15. The equine rocker shoe system of claim 11 shoe rim structure is detachable from the base.

16. The equine rocker shoe system of claim 12 wherein the shock-absorbing elastomer pad is made of a polyurethane elastomer gel, having a critical Shore A hardness of about 15-30.
